(19) United States
(12) Patent Application Publication
(10) Pub. No.: US 2007/0289210 A1
(43) Pub. Date: Dec. 20, 2007

(54) TOMATO CLAW

(76) Inventor: Scott Hunter Gray, Lawrenceville, NJ (US)

Correspondence Address: SYNNESTVEDT LECHNER & WOODBRIDGE LLP, P O BOX 592, 112 NASSAU STREET, PRINCETON, NJ, 08542-0592, US

(21) Appl. No.: 11/762,865

(22) Filed: Jun. 14, 2007

Related U.S. Application Data
(60) Provisional application No. 60/805,234, filed on Jun. 20, 2006.

(51) Int. Cl. A01G 17/14

(52) U.S. Cl. 47/47

(57) ABSTRACT

A tomato plant support device includes a pole and a plurality of claw shaped support arms which are repositionable to optimally support the plant as it grows. The bottom end of the pole is anchored in the ground by a plurality or equally spaced fins. A glider has a longitudinal aperture for engaging the pole and is attached to the claw shaped support arm. A lever having a threaded end is received in a passageway in said glider and used to selective immobilized the claw section with respect to the pole said that it can be moved and rotated when necessary. Each tomato plant support device preferably includes two or more claw shaped support arms that curve towards each other so that together they can grab a plant as it grows.

### CROSS REFERENCE TO RELATED APPLICATIONS

This application is related to, and claims priority from U.S. Provisional Patent application No. 60/805,234 filed on Jun. 20, 2006 by Scott Gray entitled “Tomato Claw”, the contents of which are hereby incorporated by reference.

### DESCRIPTION OF RELATED ART

Growing tomatoes and other plants that have weak stems but heavy fruit is not an easy task. Frequently the fruit is so heavy that it breaks off the stem or, just as bad, the stem bends severely and the tomato decays on the vine. In response to this historic problem, a variety of tomato cages and the like have been produced and are available on the market. Unfortunately, tomato cages are somewhat unwieldy and difficult for senior citizens to use easily. A discussion of the problem can be found at a URL entitled “I Hate Tomato Cages” at http://forums.gardenweb.com/forums/load/lab/msg0220484815161.html.

In response to the need for a product better than the traditional tomato cage, other devices have been invented and are described in the patent literature.

US Patent Application Publication No. US2006/0053689 describes an “Adjustable Plant support” which comprises a plurality of poles that are connected to each other by a group of arms and which can be used to support a growing vine plant. While such an approach has its advantages, it also appears to be very complicated for the typical gardener to use—especially senior citizens.

Another approach is described in U.S. Pat. No. 7,043,876 entitled “Adjustable Plant Cage” in which a single pole is employed to support a plurality of circular rings that can adjusted vertically to accommodate a plant or vine-like garden vegetable.

U.S. Pat. No. 5,640,802 entitled “Support Assembly and Method for Growing Tomato Plants and the Like” includes a plurality of round circular sections that can be plugged into each other in order to increase the height of the support as the plant grows.

The prior art also includes a number of devices which have a wire or metal rod-type structure and which are collapsible, such as found in the following U.S. Pat. Nos. 5,179,799; 6,088,956; 6,385,901; 6,453,606; and, 7,017,299. See, in addition, US Patent Publication No. US 2002/0029518.

U.S. Pat. No. 4,667,438 entitled “Tomato Cage” describes another traditional approach comprising the spacing of vertical posts around a plant and then surrounding the same with wire.

Lastly, the following two patents are cited as being of possible, but probably lesser, relevance: U.S. Pat. No. 6,874,278; and, US Publication No. US2005/0166452.

Despite the foregoing efforts, there does not yet appear to be an effective, simple and doable tomato support device that could be easily used, for example, by senior citizens.

### SUMMARY OF INVENTION

Briefly described, the invention comprises a tomato plant support which includes a plurality of claw shape support arms that can be adjusted to optimally support the tomato plant as it grows. The invention includes a pole the bottom of which is anchored into the ground by a plurality of equally spaced fins. Each of the claw shaped support arms includes a glider that has a longitudinal aperture for engaging the pole. An L-shaped lever, including a threaded end, is received in a threaded passageway in the glider and used to selectively immobilize each claw section with respect to the support pole. Because of the L-shape of the lever, it is easy for an individual, such as a senior citizen, to get sufficient leverage on the device that the glider can be easily moved up and down and adjusted and locked into position as required. Two or more claw shaped support arms are supported by each pole. At least two of the arms curve in opposite directions so that they can be pushed together and grab the plant as the plant grows.

These and other features of the invention will be more fully understood by reference to the following drawings.

### DETAILED DESCRIPTION OF THE DRAWINGS

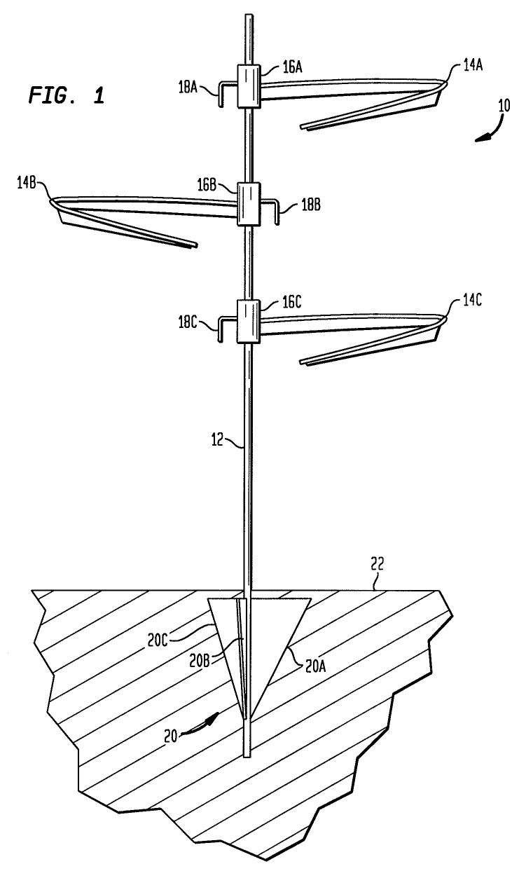

FIG. 1 is an elevational view of the preferred embodiment of the invention as anchored in the earth.

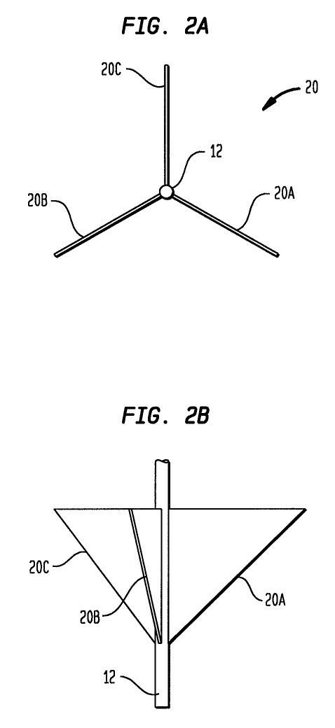

FIG. 2A is a top plan view of a three-fin pole anchor.

FIG. 2B is an elevational view of the pole anchor as shown in FIG. 2A.

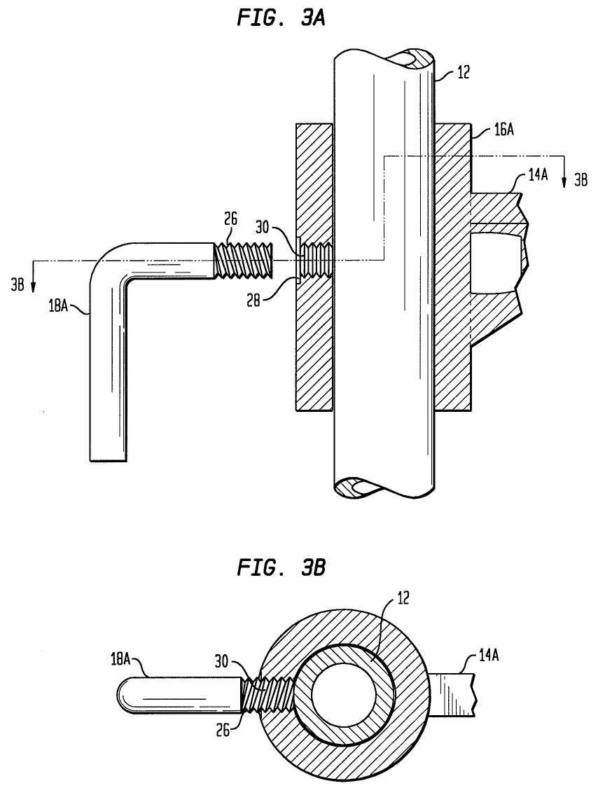

FIG. 3A is a vertical partial cross-sectional view of the arm glider and its association with a threaded locking lever.

FIG. 3B is a horizontal cross sectional view of the locking mechanism illustrated in FIG. 3A.

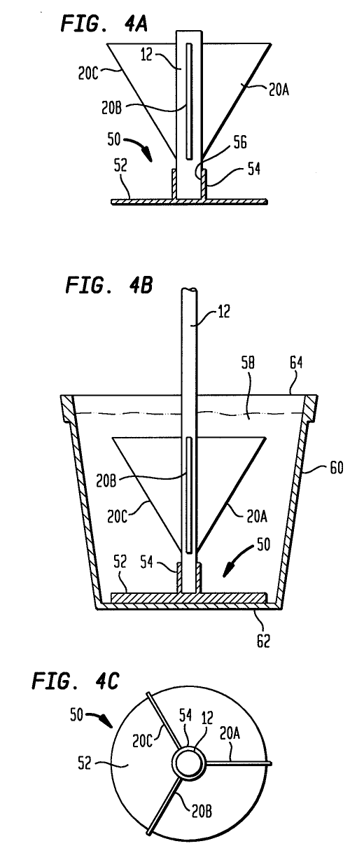

FIG. 4A illustrates an alternative embodiment in which a support stand is used to support the bottom of the pole when the invention is placed in a typical flower pot.

FIG. 4B is a cross-sectional view of a flower pot illustrating how the support stand shown in FIG. 4A is received therein.

FIG. 4C is a cross-sectional, top plan view of the support stand shown in FIGS. 4A and 4B.

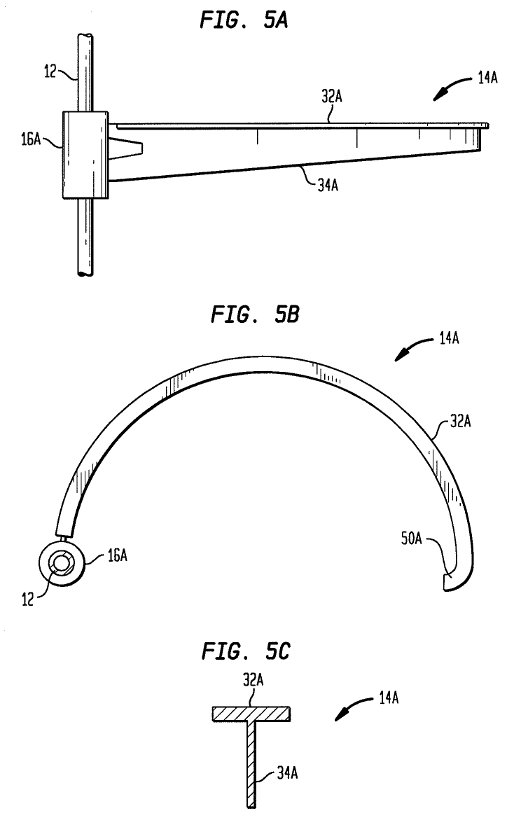

FIG. 5A is a partial elevational view of a single tomato claw section.

FIG. 5B is a top-plan view of the tomato claw shown in FIG. 5A.

FIG. 5C is a cross-sectional view of the tomato claw as shown in FIG. 5A or 5B.

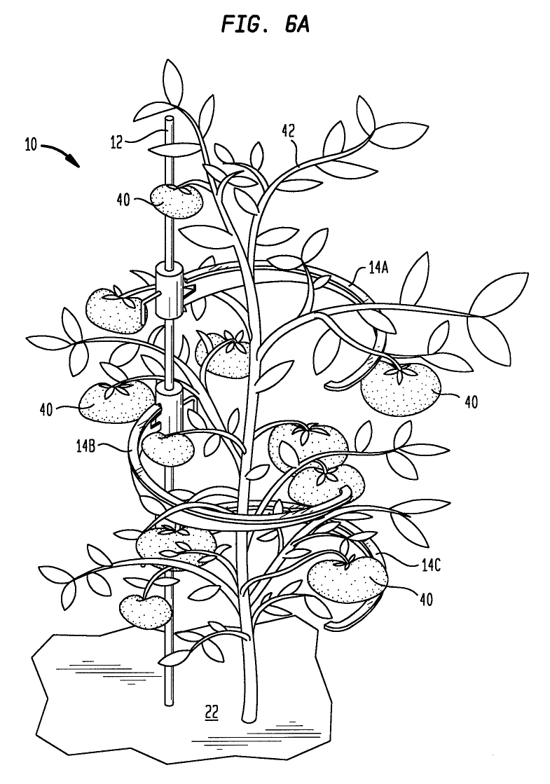

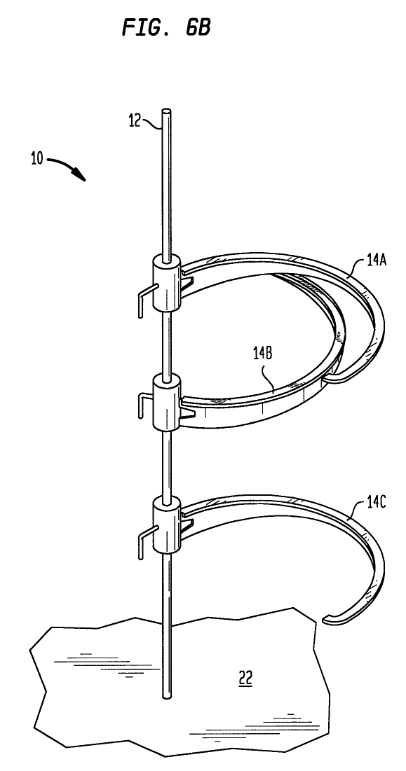

FIG. 6A is an elevational view of the tomato claw invention shown supporting a tomato plant.

FIG. 6B is an elevational view of the tomato claw invention shown in FIG. 6A with tomato plant removed.

### DETAILED DESCRIPTION OF THE INVENTION

During the course of this description, like numbers will be used to identify like elements according to the different figures that illustrate the invention.

FIG. 1 is a vertical elevational view of the preferred embodiment 10 of the invention shown planted in the earth 22. The entire apparatus 10 is supported by a single pole 12 having a top end and a bottom end. The bottom end of the pole 12 includes an anchor 20 having a plurality of fins 20A, 20B, and 20C just flush with or slightly below the surface of the earth 22. The top end of pole 12 supports a plurality of tomato claw sections 14A, 14B and 14C as shown. The invention 10 preferable comprises at least two tomato claws but could easily have three or more depending upon the nature of the plant being supported. Tomato claws 14A, 14B and 14C are attached to pole 12 by a plurality of gliders 16A, 16B and 16C, respectively. In turn, gliders 16A, 16B and 16C are locked into position by L-shaped levers 18A, 18B and 18C, respectively.

FIG. 2A is a cross-sectional view of the anchor section 20 according to the preferred embodiment 10 and FIG. 2B is a partial, elevational view of the same anchor section 20. The preferred anchor 20 includes three equally spaced fins 20A, 20B, and 20C which radiate outwardly from the center of the pole 12.

FIG. 3A is a partial cross-sectional view a glider 16A shown in association with its L-shaped locking lever 18A. One end of L-shaped lever 18A includes thread 26 which is adapted to mate with the threads 28 in aperture 30 of glider 16A. FIG. 3A illustrates the lever 18A after it has been completely unthreaded from aperture 30. In this mode it is possible to move the glider 16A and claw arm 14A up and down the pole 12.

FIG. 3B is a horizontal cross-sectional view of the glider 16A illustrated in FIG. 3A taken from prospective 3B-3B. In FIG. 3B the locking lever mechanism 18A is shown fully threaded into aperture 30 so that it impinges upon pole 12. In the mode shown in FIG. 3B the glider 16A is locked and immobilized with respect to pole 12 so that its associated tomato claw arm 14A can support the weight of a tomato plant without slipping.

FIGS. 4A-4C illustrate an alternative embodiment in which a support stand 50 is used to support the bottom of the pole 12 when the invention 10 is placed in a standard flower pot 60. The support stand 50 includes a flat, round bottom portion 52 and an upright, cylindrical, hollow collar section 54 welded to the middle of the round bottom portion 52 and having an axis that is co-axial with the axis of the round bottom section 52. FIG. 4A shows how the base of the pole 12 is snuggly received in the hollow central cavity 56 of the collar section 54. FIG. 4B shows the support stand 50 in position at the bottom 62 of flower pot 60. The round bottom portion 52 has a circumference that is just smaller than the inside circumference of the bottom 62 of the pot 60 so that the support stand 50 fits comfortably therein. FIG. 4C is a cross-sectional top plan view of the support stand 50 shown in FIGS. 4A and 4B. In this view the three fins 20A, 20B and 20 C are shown radiating outwardly from the pole 12.

The alternative embodiment 50 is used in the following manner. First, the gardener puts the support stand 50 in the bottom 62 of the pot 60. Second, the gardener places the bottom of the pole 12 into the cavity or socket 56 in the collar 54 so that the pole 12 fits snuggly therein. Third, the gardener put dirt 58 into the pot 60 almost up to the top rim 64 but not quite over it. The invention 10 is then ready to use in the same manner as if it were in a typical garden. Alternatively, the gardener could first put the plate 50 on the bottom of the pole 12 and then put the pole 12 in the pot 60 and repeat the third step above of placing dirt into the pot. Either approach will work.

FIG. 5A is an elevational view of an individual tomato claw 14A showing a relatively flat horizontal rib surface 32A and a rib-section 34A which is perpendicular to the plane of the top section 32A but lies in a plane that is parallel with the axis of the support pole 12. Support rib 34A preferable tapers from its thickest point where it attaches to glider 16A to its thinnest point at the free end of the arm 14A.

FIG. 5B is a top plan view of the rib 14A illustrating the manner in which its curves so as to optimally support the plant. The far free end of 50A of the tomato claw 14 includes an additional individual hook so that plants are less likely to slide off of the arm 14A.

FIG. 5C is a cross-sectional view of the tomato claw 14A better illustrating how the support rib 34A lies in the plane perpendicular to the upper surface 32A. The broad upper surface 32A is important because it gives more support to a heavy tomato plant that a simple wire or round metal rod.

FIG. 6A illustrates the invention 10 in the context of a tomato plant 42 from which a plurality of tomatoes 40 hang. Over the years tomatoes 40, such as Beefsteak Tomatoes, can become quite heavy and, accordingly, the need for support is more critical. Note in FIG. 5A that tomato claws 14A and 14C curve in the same direction but that the intermediate tomato claw 14B curves in the opposite direction but towards tomato claws 14A and 14C so as to effectively grab or cradle the plant.

FIG. 6B illustrates the preferred embodiment of the invention 10 with the tomato plant 40 and tomatoes 40 removed. By moving claw 14B towards or away claws 14A and 14C, it is possible to adjust the grip of the invention 10 on a tomato plant stem according to the distribution of tomatoes 40 on the plant 42.

When in use the support pole 12 of the preferred embodiment 10 is typically placed in the ground 12 near the base of the freshly planted tomato plant 42. The support pole 12 is pushed far enough into the earth so that the upper edges of fins 20A-20C are preferably either flush with the surface of the earth 22 or slightly below same. According to the preferred embodiment of the invention 10, three claws 14A-14C are employed with two of the claws 14A and 14C facing one direction and the third, 14B, opposing them. The vertical and rotational orientation of each of the arms 14A-14C is adjusted by loosening the glider support fasteners 16A-16C using the L-shaped levers 18A-18C, respectively, as previously described. In this manner each arm 14A-14C can be moved vertically along the axis of the support pole 12 and horizontally underneath the stalks of the tomato plant 42. After each branch of the tomato plant 42 is appropriately supported, the locking levers 18A-18C are tightened so that the threaded end 26 of the L-shaped locking lever impinges the pole 12 and the arms 14A-14C are locked in place. As the plant grows the arms 14A-14C are readjusted vertically and horizontally so as to provide continued optimal support. Generally a plant tends to grow upwards and outwards at the same time so that regular adjustment is desirable and necessary.

The invention 10 can be made out of a light-weight metal, such as aluminum or, alternatively, plastic products would also work provided they were hard and durable enough.

While the invention has been described with reference to a preferred embodiment thereof, it will be appreciated by those of ordinary skill in the art that various modifications can be made to the parts comprise the invention without departing from the spirit and scope of the invention as a whole.

1. A tomato plant support apparatus for supporting a tomato plant as it grows comprising:
a pole having a top end and a bottom end for placement in the ground;
at least one tomato plant support means attachable to said top end of said pole and selectively repositionable able thereon,
wherein said tomato plant support means can be repositioned so as to optimally support said tomato plant as it grows.

2. The apparatus of claim 1 further comprising:
anchor means attached to said bottom end of said pole for anchoring said apparatus in the ground.

3. The apparatus of claim 2 wherein said anchor means comprises at least one fin.

4. The apparatus of claim 3 wherein said tomato plant support means comprises:
a curved, claw shaped section for contacting said tomato plant; and,
a glider section attached to one end of said claw shaped section, said glider section including an aperture therein for receiving and surrounding a portion of said pole.

5. The apparatus of claim 4 wherein said tomato plant support means further comprises:
fastener means attached to said glider section for selectively immobilizing said claw shaped section with respect to said pole and for selectively disengaging said claw shaped section with respect to said pole so that said tomato support means can be repositioned was said tomato plant grows.

6. The apparatus of claim 5 wherein said glider section includes a threaded passageway extending from the exterior of said glider section to said pole receiving aperture therein.

7. The apparatus of claim 6 wherein said fastener comprises a lever having a first end and a second end and wherein said second end includes threads thereon,
wherein said threads on said lever are received by the threads in said threaded passageway on said glider section so that when said lever is rotated said second end of said lever contacts said pole and immobilizes the tomato support means with respect to said pole.

8. The apparatus of claim 7 wherein said tomato claw shaped section of said tomato plant support means comprises:
a substantially flat horizontal shelf having a top and a bottom attached to said glider section, said substantially flat horizontal shelf having a top and a bottom; and,
a substantially vertical shelf support section attached to said glider section and to the bottom of said shelf.

9. The apparatus of claim 8 wherein said shelf support section tapers and gets more narrow the further it gets from said glider section.

10. The apparatus of claim 9 further comprising at least a first and a second tomato plant support section and wherein the claw on said first and second tomato plant support sections curve in opposite directions with respect to each other.

11. The apparatus of claim 10 wherein the claw sections of said first and second tomato plant support sections curve towards each other.

12. The apparatus of claim 11 wherein said apparatus comprises at least three tomato support sections.

13. The apparatus of claim 12 wherein said anchor means comprised at least two fins spaced equidistant from each other in a plane horizontal to the axis of said pole.

14. The apparatus of claim 13 wherein said anchor means comprised three fins spaced equidistant from each other in a plane horizontal to the axis of said pole.

15. The apparatus of claim 14 wherein such claw sections include a hook at the free end thereof to help prevent a tomato plant from sliding off of said claw section.

16. The apparatus of claim 15 further comprising:
a support stand for receiving the bottom end of said pole so that said apparatus can stand upright when positioned on a relatively flat surface.

17. The apparatus of claim 16 wherein said support stand comprises:
a relatively flat circular base; and,
a cylindrical, hollow collar attached to the middle of said base, said collar having a cavity therein for receiving said bottom end of said pole.

18. The apparatus of claim 17 wherein said support stand is receivable in a plant pot having sidewall and a bottom and wherein said circular base of said support stand makes contact with said pot bottom so that when said pot is filled with dirt said fins are substantially, completely covered with dirt.
